(19) United States
(12) Patent Application Publication
(10) Pub. No.: US 2018/0326565 A1
(43) Pub. Date: Nov. 15, 2018

(54) Tool Bit Coupling Assembly

(71) Applicant: Compass Corporation, Tainan City (TW)

(72) Inventor: Tzu-Chien Wang, Tainan City (TW)

(21) Appl. No.: 15/593,363

(22) Filed: May 12, 2017

(51) Int. Cl. B25B 23/00; B23B 31/107

(52) U.S. Cl. CPC B25B 23/0035; B23B 2260/10; B23B 31/1071

(57) ABSTRACT

A tool bit coupling assembly includes a coupling rod having an insertion end receiving a coupling device. A slideable sleeve is movable on the insertion end. A receiving hole of the slideable sleeve is larger than the insertion end and includes a coupling section. The insertion end of the coupling rod is received in a rear stop ring including a smaller diameter portion slightly smaller than an inner diameter of the coupling section. The rear stop ring further includes a larger diameter portion slightly larger than the inner diameter of the coupling section. The first coupling section of the slideable sleeve is firstly coupled with the smaller diameter portion of the rear stop ring. When the slideable sleeve is moved toward the driving end of the coupling rod, the coupling section of the slideable sleeve is tightly fit around the larger diameter portion of the rear stop ring.

### BACKGROUND OF THE INVENTION

The present invention relates to a tool bit coupling assembly and, more particularly, to a tool bit coupling assembly providing increased defect-free ratio and improved quality.

The heads of conventional tools have many shapes including a flat head, a Phillip head, a hexagonal shape, etc. To provide wider applications, tool couplers capable of coupling with bits of various head shapes have been developed. A typical tool coupler generally includes a driving end for coupling with an automatic tool or a manual tool and an insertion end for coupling with a tool bit of a screwdriver or another tool. Furthermore, the typical tool coupler generally includes a slideable sleeve for easy assembly and detachment of the tool bit.

FIG. 6 shows a conventional tool bit coupling assembly including a coupling rod 1′, a coupling device 2′, and a sleeve device 3′. The coupling rod 1′ includes a driving end 11′ and an insertion end 12′. The insertion end 12′ includes a central insertion groove 121′. An annular groove 122′ is defined in an outer periphery of the insertion end 12′. The coupling device 2′ is mounted in the insertion groove 121′. The sleeve device 3′ includes a slideable sleeve 31′, a front stop ring 32′, a spring 33′, and a rear stop ring 34′. The slideable sleeve 31′ includes a receiving hole 311′ having a middle section 312′ with an inner diameter larger than an inner diameter of the front end of the receiving hole 311′. The receiving hole 311′ further includes a coupling section 313′ located behind the middle section 312′ and having an inner diameter A. The front stop ring 32′ is disposed in the annular groove 122′. The spring 33′ is disposed behind the front stop ring 32′. The rear stop ring 34′ is mounted around the insertion end 12′ and is located behind the front stop ring 32′. An outer diameter B of the rear stop ring 34′ is slightly larger than the inner diameter A of the coupling section 313′ of the slideable sleeve 31′. The rear stop ring 34′ includes an inclined guiding face 341′ at a front end thereof.

In assembly, the coupling device 2′ and the slideable sleeve device 3′ are mounted around the coupling rod 1′. The rear stop ring 34′ is mounted around the coupling rod 1′ from a rear end of the coupling rod 1′. A rearward axial force is applied to the slideable sleeve 31′ to tightly couple an inner periphery of the coupling section 313′ with an outer periphery of the rear stop ring 34′. The slideable sleeve 31′ is slideable along the axial direction of the coupling rod 1′ without the risk of disengagement.

However, when the force applied to the slideable sleeve 31′ is not coincident with the axial direction or the coupling between the coupling section 313′ of the slideable sleeve 31′ and the rear stop ring 34′ deviates from the correct position, the slideable sleeve 31′ deviates from the axial direction after assembly, leading to damage to the slideable sleeve 31′ or the whole tool bit coupling assembly. Thus, the defect-free rate of assembly is low, and the costs increase significantly.

### BRIEF SUMMARY OF THE INVENTION

An objective of the present invention is to provide a tool bit coupling assembly providing increased defect-free ratio and improved quality.

A tool bit coupling assembly according to the present invention includes a coupling rod having a driving end and an insertion end opposite to the driving end. The insertion end includes an insertion groove extending along a longitudinal axis. A coupling device is mounted in the insertion groove. A sleeve device includes a slideable sleeve movable on the insertion end of the coupling rod along the longitudinal axis. The slideable sleeve includes a receiving hole having an inner diameter larger than an outer diameter of the insertion end. The receiving hole of the slideable sleeve further includes a coupling section at a rear end thereof. The sleeve device further includes a rear stop ring having a receiving hole. The insertion end of the coupling rod is received in the receiving hole of the rear stop ring. The rear stop ring further includes a smaller diameter portion having an outer diameter slightly smaller than an inner diameter of the coupling section of the slideable sleeve. The rear stop ring further includes a larger diameter portion having an outer diameter slightly larger than the inner diameter of the coupling section of the slideable sleeve. An inclined guiding face is formed between the smaller diameter portion and the larger diameter portion. The first coupling section of the slideable sleeve is firstly coupled with the smaller diameter portion of the rear stop ring. When the slideable sleeve is moved toward the driving end of the coupling rod along the longitudinal axis, an inner periphery of the coupling section of the slideable sleeve is tightly fit around the larger diameter portion of the rear stop ring.

In an example, the larger diameter portion is located at an intermediate portion of the rear stop ring. The slideable sleeve further includes an additional smaller diameter portion. The larger diameter portion is located between the smaller diameter portions. An additional inclined guiding face is formed between the larger diameter portion and the additional smaller diameter portion.

In an example, the insertion end of the coupling rod includes a front positioning hole and a rear positioning hole. Each of the front positioning hole and the rear positioning hole extends in a radial direction perpendicular to the longitudinal axis and intercommunicates with the insertion groove. The insertion end of the coupling rod further includes an annular groove in an outer periphery thereof. The coupling device includes a magnetic device, a front positioning ball received in the front positioning hole, and a rear positioning ball received in the rear positioning hole. The sleeve device further includes a front stop ring and a spring. The receiving hole of the slideable sleeve includes a mediate section having an inner diameter larger than an inner diameter of a front end of the receiving hole of the slideable sleeve. The coupling section is located behind the mediate section. The front stop ring is mounted in the annular groove of the coupling rod and has an outer diameter larger than the inner diameter of the front end of the receiving hole of the slideable sleeve and smaller than the inner diameter of the mediate section. The spring is located behind the front stop ring and providing elasticity for movement of the slideable sleeve. The receiving hole of the rear stop ring includes a ball receiving groove for receiving the rear positioning ball.

In an example, the receiving hole of the rear stop ring includes an inclined face on an end edge thereof.

In assembly, the coupling section of the slideable sleeve is firstly in a position covering the smaller diameter portion of the rear stop ring and can be positioned along the longitudinal axis. Then, the slideable sleeve is moved rearward or the rear stop ring is moved forward along the longitudinal axis to make the coupling section of the slideable sleeve move along the inclined guiding face and expand. An inner periphery of the coupling section of the slideable sleeve moves across the smaller diameter portion and is then tightly fit around the larger diameter portion of the rear stop ring. Since the tool bit coupling assembly according to the present invention is applied with a force to proceed with assembly after the axial positioning, deviation from the longitudinal axis will not occur during the assembling procedure, significantly increasing the defect-free rate and improving the quality. Furthermore, after assembly, the inclined face of the rear stop ring abuts the rear positioning ball, providing smooth forward movement of the rear stop ring.

The present invention will become clearer in light of the following detailed description of illustrative embodiments of this invention described in connection with the drawings.

### DESCRIPTION OF THE DRAWINGS

FIG. 1 is a perspective view of a tool bit coupling assembly of an embodiment according to the present invention.

FIG. 2 is a partial, cross sectional view of the tool bit coupling assembly of FIG. 1 with the tool bit coupling assembly in an untightened assembled state.

FIG. 3 is a partial, cross sectional view of the tool bit coupling assembly of FIG. 1 with the tool bit coupling assembly in a tightened assembled state.

FIG. 4 is a view similar to FIG. 3 with a rear stop ring moved to a locking position.

FIG. 5 is a view similar to FIG. 4 with the rear stop ring moved to an unlocking position.

FIG. 6 is a partial, cross sectional view of a conventional tool bit coupling assembly in an untightened assembled state.

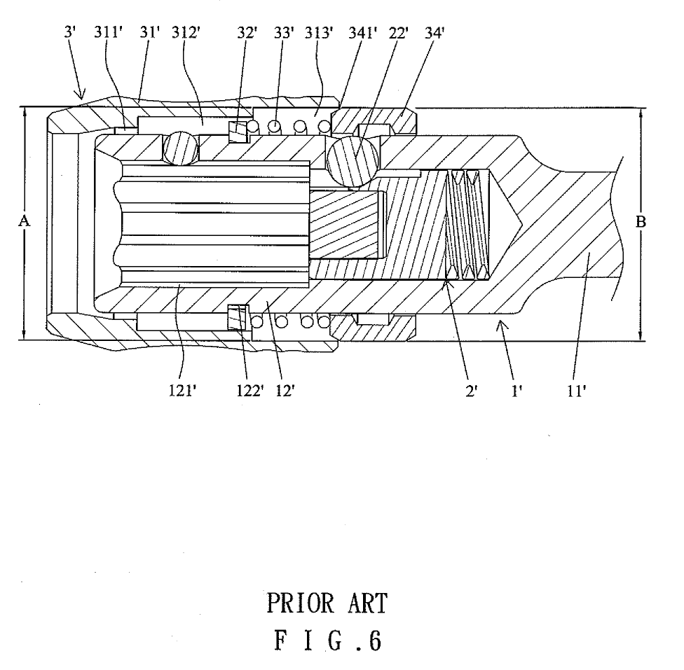

FIG. 7 is a partial cross sectional view of the conventional tool bit coupling assembly in a tightened assembled state.

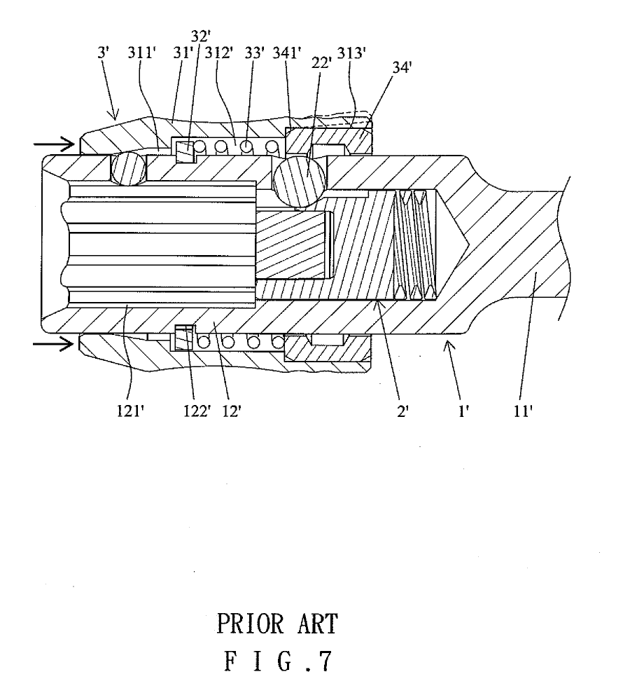

### DETAILED DESCRIPTION OF THE INVENTION

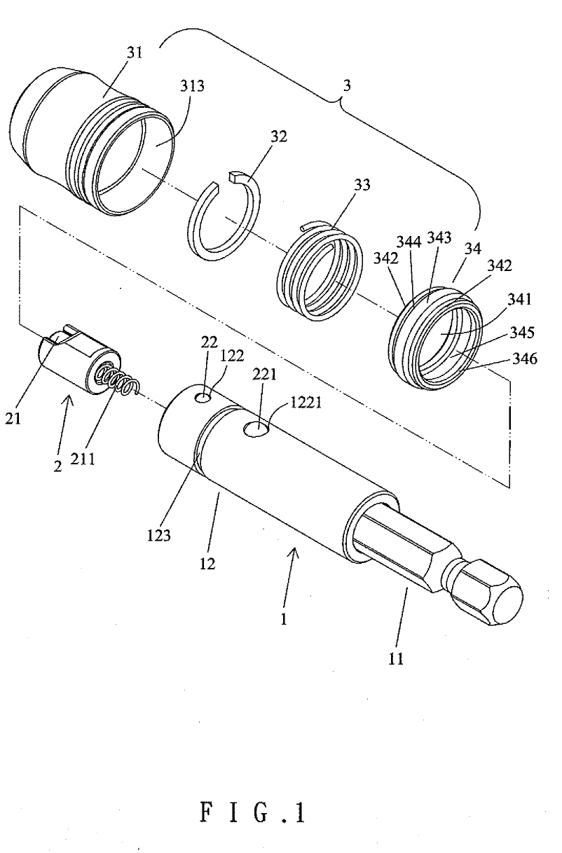

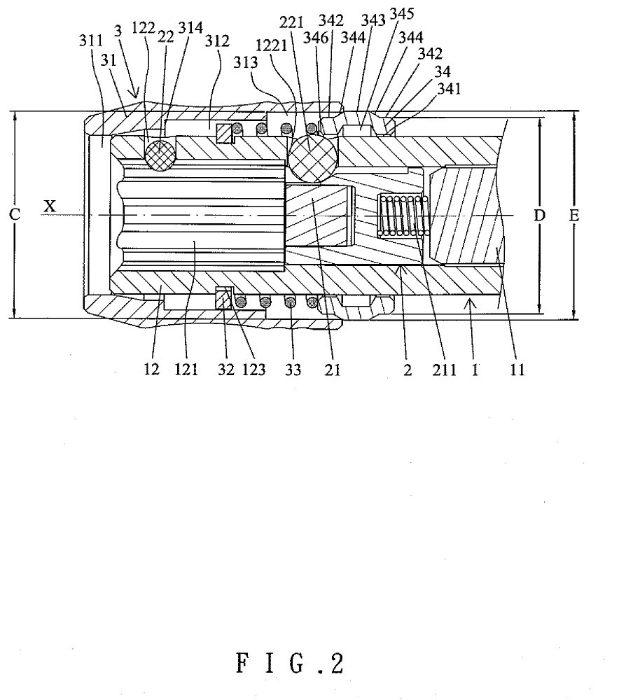

With reference to FIGS. 1 and 2, a tool bit coupling assembly of an embodiment according to the present invention includes a coupling rod 1, a coupling device 2, and a sleeve device 3. The coupling rod 1 includes a driving end 11 adapted for coupling with a manual tool or an automatic tool (not shown). The coupling rod 1 further includes an insertion end 12 opposite to the driving end 11. The insertion end 12 includes an insertion groove 121 extending along a longitudinal axis X. The insertion end 12 further includes a front positioning hole 122 and a rear positioning hole 1221. Each of the front positioning hole 122 and the rear positioning hole 1221 extends in a radial direction perpendicular to the longitudinal axis X and intercommunicates with the insertion groove 121. The insertion end 12 further includes an annular groove 123 in an outer periphery thereof.

The coupling device 2 is mounted in the insertion groove 121 and can be used to couple with a screwdriver bit. The coupling device 2 includes a magnetic device 21, a front positioning ball 22 received in the front positioning hole 122, and a rear positioning ball 221 received in the rear positioning hole 1221. A spring 211 is mounted behind the magnetic device 21.

The sleeve device 3 includes a slideable sleeve 31, a front stop ring 32, a spring 33, and a rear stop ring 34. The slideable sleeve 31 includes a receiving hole 311 having an inner diameter larger than an outer diameter of the insertion end 12. The receiving hole 311 of the slideable sleeve 31 includes a mediate section 312 having an inner diameter larger than an inner diameter of a front end of the receiving hole 311 of the slideable sleeve 31. The receiving hole 311 of the slideable sleeve 31 further includes a coupling section 313 at a rear end thereof. The coupling section 313 has an inner diameter C. A shoulder 314 is formed between the front end of the receiving hole 311 and the mediate section 312. The front stop ring 32 is mounted in the annular groove 123 of the coupling ring 1 and can abut the shoulder 314. An outer diameter of the front stop ring 32 is larger than the inner diameter of the front end of the receiving hole 311 of the slideable sleeve 31 and is smaller than the inner diameter of the mediate section 312. The spring 33 is located behind the front stop ring 32. The spring 33 is attached between the front stop ring 32 and the rear stop ring 34 to provide elasticity for movement of the slideable sleeve 31.

The rear stop ring 34 includes a receiving hole 341 having a diameter larger than the outer diameter of the insertion end 12 of the coupling rod 1. The rear stop ring 34 further includes a smaller diameter portion 342 having an outer diameter D slightly smaller than the inner diameter C of the coupling section 313 of the slideable sleeve 31. The rear stop ring 34 further includes a larger diameter portion 343 located behind the smaller diameter portion 342 having an outer diameter E slightly larger than the inner diameter C of the coupling section 313 of the slideable sleeve 31. Namely, the outer diameter E is larger than the inner diameter C, which, in turn, is larger than the outer diameter D. An inclined guiding face 344 is formed between the smaller diameter portion 342 and the larger diameter portion 343. An inner periphery of the receiving hole 341 of the rear stop ring 34 includes a ball receiving groove 345 for receiving the rear positioning ball 221. In this embodiment, the larger diameter portion 343 is located at an intermediate portion of the rear stop ring 34. The slideable sleeve 31 further includes an additional smaller diameter portion 342. The larger diameter portion 343 is located between the smaller diameter portions 342. An additional inclined guiding face 344 is formed between the larger diameter portion 343 and the additional smaller diameter portion 342. Furthermore, the receiving hole 341 of the rear stop ring 34 includes an inclined face 346 on each of a front end edge and a rear end edge thereof. Thus, the present invention can be easily assembled without limitation in orientation.

In assembly, the coupling device 2 and the sleeve device 3 are mounted on the coupling rod 1. The rear stop ring 34 is mounted from the rear end of the coupler 1 to the outer edge of the insertion portion 12. Furthermore, the slideable sleeve 31 is moved along the longitudinal axis X to a position in which the coupling section 313 firstly covers the smaller diameter portion 342 of the rear stop ring 34 and can be positioned along the longitudinal axis X (see FIG. 2).

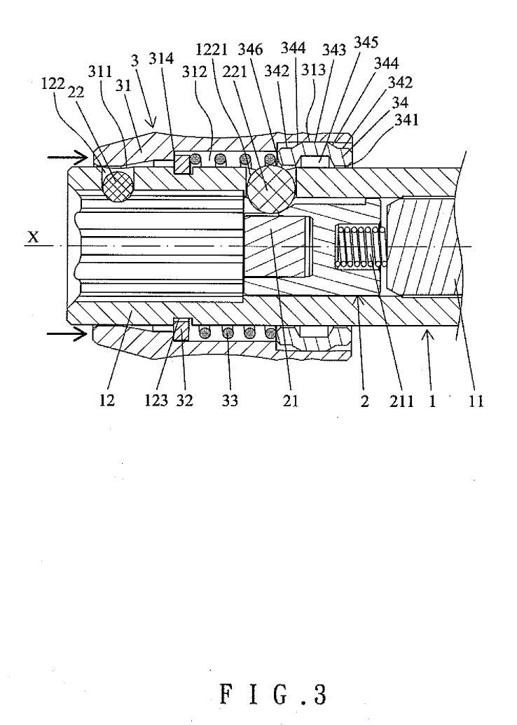

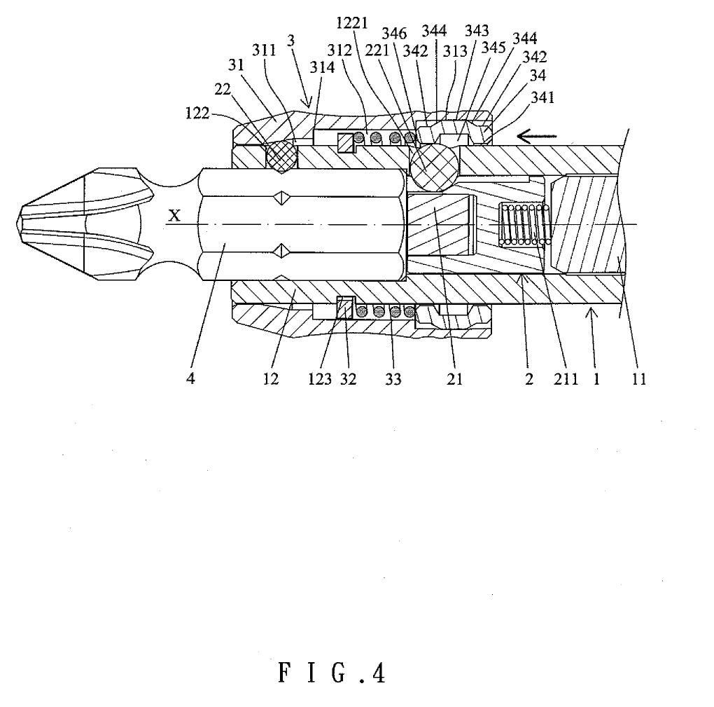

With reference to FIG. 3, the slideable sleeve 31 is moved rearward toward the driving end 11 of the coupling rod 1 along the longitudinal axis X. The coupling section 313 of the slideable sleeve 31 moves along the inclined guiding face 344 and expands. An inner periphery of the coupling section 313 of the slideable sleeve 31 moves across the smaller diameter portion 342 and is then tightly fit around the larger diameter portion 343 of the rear stop ring 34. Since the tool bit coupling assembly according to the present invention is applied with a force to proceed with assembly after the axial positioning, deviation from the longitudinal axis X will not occur during the assembling procedure, significantly increasing the defect-free rate and improving the quality. With reference to FIG. 4, after assembly, the rear stop ring 34 can be located behind the most protruded position of the rear positioning ball 221 in the radial direction (see FIG. 3). Thus, the inclined face 346 can slide along the rear positioning ball 221 after guiding the rear stop ring 34. Additional tool is not required for pushing the slideable sleeve 31 forward, and the rear stop ring 34 can smoothly move forward to the locking position.

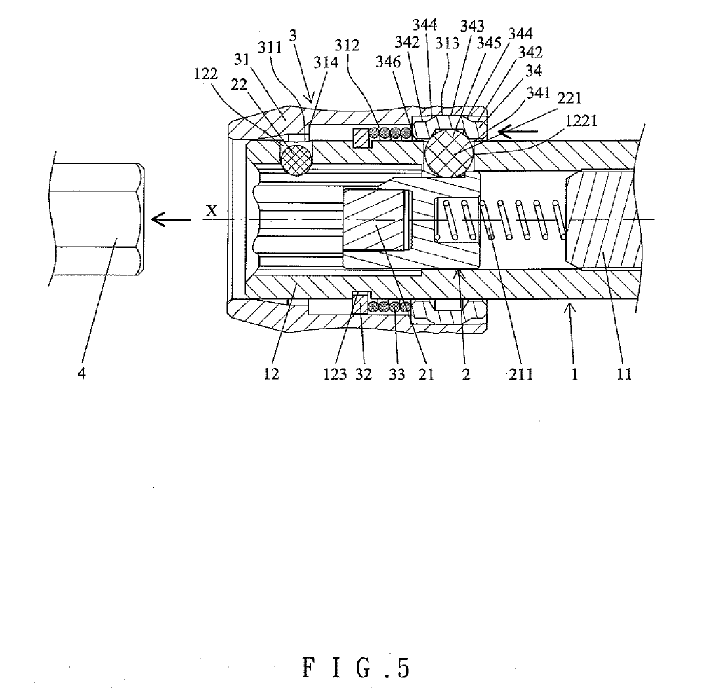

After assembly, a screwdriver bit 4 or another tool bit can be inserted into the insertion groove 121 and can be magnetically positioned by the magnetic device 21. As shown in FIG. 4, the slideable sleeve 31 is moved rearward by the elastic force of the spring 33 to a position in which the ball receiving groove 345 is not aligned with the rear positioning ball 221. Thus, the magnetic device 21 is positioned, and the front positioning ball 22 engages with the screwdriver bit 4. With reference to FIG. 5, the slideable sleeve 31 can be moved forward along the longitudinal axis X to disengage the screwdriver bit 4 from the insertion groove 121. Thus, movement of the slideable sleeve 21 along the longitudinal axis X can be used to control coupling or detachment of the screwdriver bit 4. Thus, the slideable sleeve 31 provides better axial assembling precision to prevent jamming during assembly, thereby increasing the operational smoothness.

Thus, the present invention significantly increases the detect-free rate and improves the quality, assuring long-term smooth operation along the longitudinal axis X. It can be appreciated that the coupling device 2 and the sleeve device 3 can use other components. The present invention is not limited to the structure of the above mentioned embodiments.

Although specific embodiments have been illustrated and described, numerous modifications and variations are still possible without departing from the scope of the invention. The scope of the invention is limited by the accompanying claims.

1. A tool bit coupling assembly comprising:
a coupling rod including a driving end and an insertion end opposite to the driving end, with the insertion end including an insertion groove extending along a longitudinal axis;
a coupling device mounted in the insertion groove;
a sleeve device including a slideable sleeve movable on the insertion end of the coupling rod along the longitudinal axis, with the slideable sleeve including a receiving hole having an inner diameter larger than an outer diameter of the insertion end, with the receiving hole of the slideable sleeve further including a coupling section at a rear end thereof, with the sleeve device further including a rear stop ring having a receiving hole, with the insertion end of the coupling rod received in the receiving hole of the rear stop ring, with the rear stop ring further including a smaller diameter portion having an outer diameter slightly smaller than an inner diameter of the coupling section of the slideable sleeve, with the rear stop ring further including a larger diameter portion having an outer diameter slightly larger than the inner diameter of the coupling section of the slideable sleeve, with an inclined guiding face formed between the smaller diameter portion and the larger diameter portion, wherein the first coupling section of the slideable sleeve is firstly coupled with the smaller diameter portion of the rear stop ring, wherein when the slideable sleeve is moved toward the driving end of the coupling rod along the longitudinal axis, an inner periphery of the coupling section of the slideable sleeve is tightly fit around the larger diameter portion of the rear stop ring.

2. The tool bit coupling assembly as claimed in claim 1, with the larger diameter portion located at an intermediate portion of the rear stop ring, with the slideable sleeve further including an additional smaller diameter portion, with the larger diameter portion located between the smaller diameter portions, and with an additional inclined guiding face formed between the larger diameter portion and the additional smaller diameter portion.

3. The tool bit coupling assembly as claimed in claim 1, with the insertion end of the coupling rod including a front positioning hole and a rear positioning hole, with each of the front positioning hole and the rear positioning hole extending in a radial direction perpendicular to the longitudinal axis and intercommunicated with the insertion groove, with the insertion end of the coupling rod further including an annular groove in an outer periphery thereof, with the coupling device including a magnetic device, a front positioning ball received in the front positioning hole, and a rear positioning ball received in the rear positioning hole, with the sleeve device further including a front stop ring and a spring, with the receiving hole of the slideable sleeve including a mediate section having an inner diameter larger than an inner diameter of a front end of the receiving hole of the slideable sleeve, with the coupling section located behind the mediate section, with the front stop ring mounted in the annular groove of the coupling rod and having an outer diameter larger than the inner diameter of the front end of the receiving hole of the slideable sleeve and smaller than the inner diameter of the mediate section, with the spring located behind the front stop ring and providing elasticity for movement of the slideable sleeve, and with the receiving hole of the rear stop ring including a ball receiving groove for receiving the rear positioning ball.

4. The tool bit coupling assembly as claimed in claim 3, wherein the receiving hole of the rear stop ring includes an inclined face on an end edge thereof.
